(19) United States
(12) Patent Application Publication
(10) Pub. No.: US 2026/0211947 A1
(43) Pub. Date: Jul. 23, 2026

(54) ARTIFICIAL INTELLIGENCE MODEL DEVELOPMENT INTERFACE

(71) Applicant: Xedena, Inc., Brooklyn, NY (US)

(72) Inventor: Paris L. Blaisdell-Pijuan, Bend, OR (US)

(21) Appl. No.: 19/054,059

(22) Filed: Feb. 14, 2025

Related U.S. Application Data
(60) Provisional application No. 63/553,293, filed on Feb. 14, 2024.

(51) Int. Cl. G06F 16/903

(52) U.S. Cl. CPC G06F 16/90335

(57) ABSTRACT

A method of processing data in a distributed computing system includes receiving, by a first device, a query from a user. The first device determines, based on the query, a model for processing the query and whether the first device or a second device includes the model for processing the query. Based on whether the first device or the second device includes the model for processing the query, the first device transmits the query to the second device for processing, and provides a response to the query to the user.

### CROSS REFERENCE TO RELATED APPLICATIONS

This Application claims the benefit of U.S. Provisional Patent Application No. 63/553,293, filed Feb. 14, 2024, the contents of which are incorporated by reference herein in its entirety as if fully set forth.

### FIELD

Illustrative embodiments generally relate to artificial intelligence models, more particularly, various embodiments relate to an artificial intelligence model development interface.

### BACKGROUND

The rise of artificial intelligence (AI) has provided valuable information processing being available to provide real-time intelligent results to queries. To implement AI, large language models (LLMs) may be employed which are models capable of generating human language and performing tasks based on natural requests.

These LLMs may be employed in servers/computers that are located locally or remote from one another.

### SUMMARY

In accordance with one embodiment of the invention, a method of processing data in a distributed computing system includes receiving, by a first device, a query from a user. The first device determines, based on the query, a model for processing the query and whether the first device or a second device includes the model for processing the query. Based on whether the first device or the second device includes the model for processing the query, the first device transmits the query to the second device for processing, and provides a response to the query to the user.

In some embodiments, the model is an artificial intelligence (AI) model.

In some embodiments, the first device is a computing device.

In some embodiments, the first device is in communication with an input that receives the query from the user.

In some embodiments, the determining a model for processing the query includes determining a complexity of the model for processing the query.

In some embodiments, the complexity of the model includes one or more of the following: a simple neural network, a recurrent neural network (RNN), a convolutional neural network (CNN), a deep neural network (DNN), a generative adversarial network (GAN), a variational autoencoder (VAE), a transformer model, or an advanced model.

In some embodiments, the determining a model for the processing of the query by the first device further includes: defining a problem and objectives; determining data characteristics; determining one or more models the user has utilized previously; selecting a learning paradigm; evaluating model complexities and resources; and performing iterative testing and validation of the model.

In accordance with one embodiment of the invention, a distributed computing system includes a first device comprising one or more processors in communication with a memory and an input. The processor of the first device is configured to receive a query from a user via the input, determine, based on the query, a model for processing the query, determine whether the first device or a second device includes the model for processing the query, based on whether the first device or the second device includes the model for processing the query, transmit the query to the second device for processing, and provide a response to the query to the user via an output.

In some embodiments, the model is an artificial intelligence (AI) model.

In some embodiments, the first device is a computing device.

In some embodiments, the first device is in communication with an input that receives the query from the user.

In some embodiments, the process is further configured to determine a model for processing the query includes determining a complexity of the model for processing the query.

In some embodiments, the complexity of the model includes one or more of the following: a simple neural network, a recurrent neural network (RNN), a convolutional neural network (CNN), a deep neural network (DNN), a generative adversarial network (GAN), a variational autoencoder (VAE), a transformer model, or an advanced model.

In some embodiments, the processor of the first device is further configured to: define a problem and objectives; determine data characteristics; determine one or more models the user has utilized previously; select a learning paradigm; evaluate model complexities and resources; and perform iterative testing and validation of the model.

In accordance with one embodiment of the invention, a computer program product for use on a computer system, the computer program product comprising a tangible, non-transient computer usable medium having computer readable program code thereon, the computer readable program code includes program code for receiving, by a first device, a query from a user; program code for determining, by the first device, based on the query, a model for processing the query; program code for determining, by the first device, whether the first device or a second device includes the model for processing the query; program code for, based on whether the first device or the second device includes the model for processing the query, transmitting, by the first device, the query to the second device for processing; and program code for providing, by the first device, a response to the query to the user.

In some embodiments, the model is an artificial intelligence (AI) model.

In some embodiments, the first device is a computing device.

In some embodiments, the first device is in communication with an input that receives the query from the user.

In some embodiments, the computer program product further includes program code for determining a complexity of the model for processing the query.

In some embodiments, the computer program product further includes program code for defining a problem and objectives; program code for determining data characteristics; program code for determining one or more models the user has utilized previously; program code for selecting a learning paradigm; program code for evaluating model complexities and resources; and program code for performing iterative testing and validation of the model.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an example distributed computing system in accordance with illustrative embodiments of the invention.

FIG. 2 schematically shows a diagram of an example implementation of the example distributed computing system of FIG. 1 in accordance with illustrative embodiments of the invention.

FIG. 3 shows a flow diagram of an example method for processing a query in accordance with illustrative embodiments of the invention.

FIG. 4 shows an example configuration screen in accordance with illustrative embodiments of the invention.

FIG. 5 shows an example system control and system selection screen in accordance with illustrative embodiments of the invention.

FIG. 6 shows and example system control and research mode screen in accordance with illustrative embodiments of the invention.

FIG. 7 shows an example project using multiple screens in accordance with illustrative embodiments of the invention.

FIG. 8 shows an example computing device in accordance with various embodiments.

### DESCRIPTION OF ILLUSTRATIVE EMBODIMENTS

In illustrative embodiments, a private, user-controlled, monolithic data center in a home or office environment provides compute/processing power and data resources of a computer with large orders of magnitude in the hands of the consumer. The data center may employ large language models (LLMs) that are able to interface with one or more users to provide artificial intelligence (AI) processing among multiple devices.

The compute power of multiple devices is leveraged to provide a much more powerful distributed computing system than individual devices alone. In various embodiments, the data centers may reside in a single location, while in other various embodiments, one or more of the data centers may reside remotely to others.

To this end, consumers/users are provided with privacy, control, and access to participate in a free market for data. In various embodiments, this may take the form of a distributed, consumer-to-consumer, decentralized way to develop and build future data infrastructure. To leverage AI technology among various computing systems, described herein is a user-facing computer that is built on a monolithic data center and a novel operating system that partitions the data center (locally sited to the user) in such a way to provide full automation and deployment of AI functionalities in parallel such that the user can unlock a new regime of what is possible to do on a computer and orders of magnitude greater productivity and focus.

In various embodiments, multiple users may collaborate to do projects and individual users may access extensive computing functionality easily simply by voice interaction.

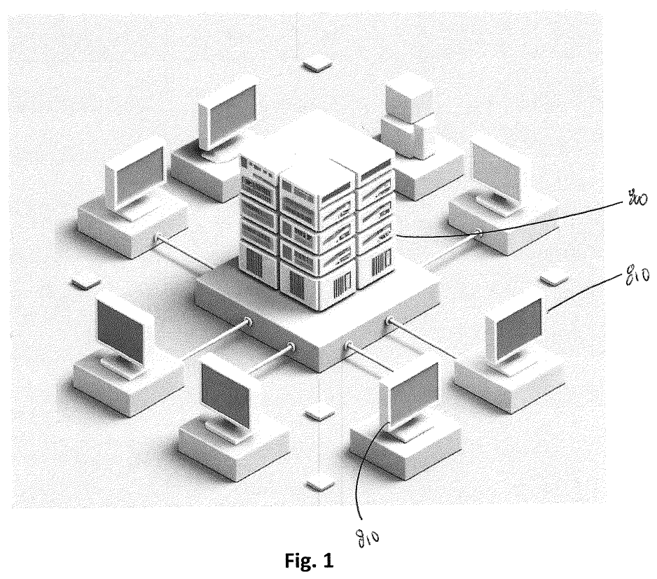

FIG. 1 schematically shows an example distributed computing system in accordance with illustrative embodiments of the invention. The distributed computing system includes one or more computing devices 800, which in various embodiments may be data centers/computers and one or more external devices 810 for interacting with. In various embodiments, the external devices 810 are connected (wired or wirelessly) with one or more computing devices 800.

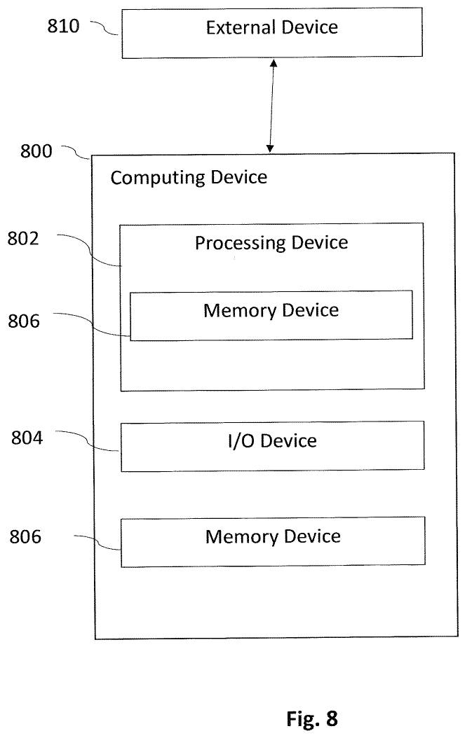

Although further detail regarding the computing devices 800 and the external devices is described below with respect to FIG. 8, in various embodiments, the external devices 810 may be screens capable of voice interaction (e.g., including microphones/speakers) to receive commands and provide visual information for a user to process.

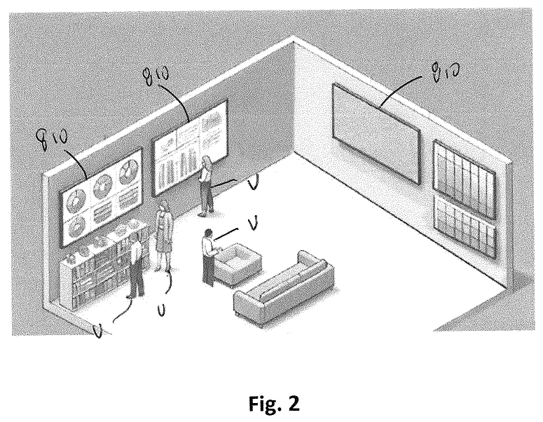

Accordingly, FIG. 2 schematically shows a diagram of an example implementation of the example distributed computing system of FIG. 1 in accordance with illustrative embodiments of the invention. Although further detail is provided below, briefly, one or more users U interact with one or more external devices 810. In various embodiments, the users U provide voice commands which are registered by, for example, microphones in the external devices 810 that transmit them to the computing device 800.

In various embodiments, the voice commands may be in the form of queries where the users are interested in performing a task or acquiring information. The computing device 800 accordingly processes the received query to determine an AI model for completing the task. In various embodiments, the AI model may execute on the computing device 800, or the computing device 800 receiving the query may determine an AI model that would effectively perform the processing is on another computing device 800.

In various embodiments, for example, a user U may speak a command to one of the external devices 810 to process a query. For example, a query may include any type of query that the user U is interested in processing, such as a request as to what the capital of France may be. The external device 810 receives the query and via its connection to the computing device 800, transmits the information to the computing device 800, which may process the query.

Accordingly, a consumer cloud is created for data infrastructure. In various embodiments, a free, accessible market for data and information, decentralized, private, and controlled by the people is provided. In various embodiments, described herein is a solution for consumer data privacy, control, & accessible free markets for data that enables distributed consumer-owned data centers, and community-investor owned community servers (e.g., in their own homes).

In various embodiments, a distributed computing system may be utilized by businesses that supply data resources for running AI and end-products delivered to consumers, commercial consumers that develop products for retail consumers by paying big tech oligopolies for supply and sell end-products delivered to consumers for which their is an operating expense to supply to consumers, and retail consumers, who purchase via subscription service fees, both AI products and data storage/management solutions to both commercial consumers offering them products, and big tech products being sold to them directly.

In various embodiments, distributed computing systems (e.g., data centers) described herein provide user-privacy, control, & independence big tech clouds, unlock full potential, utility of modern AI technologies local to the consumer, and enable a decentralized data infrastructure network and consequentially a free market for compute/data. Functionality can be enabled when the user-facing operating system is designed around user-devices with a massive compute/data resource. By designing a user-facing computer on a monolithic data center, consumers can run automation, generative, and other AI technologies in parallel without cost exposure to compute resources for operation (e.g., training is different).

Accordingly, in various embodiments, the distributed computing system (e.g., described above in FIG. 1) is built on a monolithic data center (large compute resource), utilizing a custom operating system that enables user-facing interface for advanced, automated computing. In various embodiments, the distributed computing system includes an iterative, chat-styled control interface for contextualizing and driving automation system control (direct control also enabled), a suite of advanced learning and optimization models that streamline workflow and efficiency, and a specialized operating environment that is caters to various work flow types and subject matter context.

In various embodiments, the distributed computing system is built upon an iterative interaction environment, controlled by the user via an input such as a Voice User-Interface (VUI), a keyboard, a redesigned ‘laser-pointer-style’ mouse, and/or a tablet. Actions on the computer can be driven manually, but are designed to be primarily driven via iterative interactions with a ChatBot-styled LLM. This user-front end chat-styled LLM may be a context model referred to, for purposes of example herein, as North (e.g., after North Star), which drives actions within the computer. However, the context model may be referred to by any term.

In various embodiments, North contextualizes the user-directions as questions, actions, or statement, and engages the appropriate suite of action-and generative-models that drive the computer. Some of these models may be AI models, and some of these models are flexible programs that perform pre-defined array of tasks, where the flexibility aspect refers to the ability of these programs to be tweaked or altered by the AI models constituting the model suite that controls the computer.

In various embodiments, the distributed computing system's front-facing context model, North, may based on an iterative work flow, in contrast to chat-style text-to-text models where a single short or large input immediately produces some output, which may not be the final output that the user is searching for.

The user makes statements, the context-model provides options, checks if that is the right option to proceed with, and then proceeds (the depth of this iterative flow can be tuned by the user in the settings). This front-end context model controls the piping of inputs and outputs into the system, with text, image, diagram, other, generative models, and system action models attached to the backend, that collectively control the system. When appropriate, North engages the models in the backend to perform the action on the back-end, once given the execution go ahead.

As described above, the distributed computing system (data center) hosts a user-interface via one or more external devices (e.g., screens), connected to the data center via data cabling routed within the walls (or otherwise) of the room/building/environment. The screens (e.g., external device 810 of FIG. 2) may be hosted on wall mounts that seamlessly (in full form) integrate with the wall and allow for the screens to be moved into a variety of positions and configurations to best suit the user's comfort.

In various embodiments, the screens can modularly attach and detach from the wall ports and connect to wall ports of any other screens and/or computing devices 800, making them modular, configurable, cheaper, and exchangeable/shareable with multiple people throughout a variety of different environments. In various embodiments, system is designed to be integrated with several screens, fully configurable, with suggested purpose-specific integration defaults, but can be hosted on a single screen. The system can be controlled manually or via automation with the context-model interface. As described above, the input techniques may vary to control the entire system (computing devices 800 and external devices 810), such as Voice User Interface (audio-to-text model), a mouse (e.g., as a laser pointer with several buttons and a microphone), a keyboard (for manual inputs), and/or a tablet (for controlling elements on the screen).

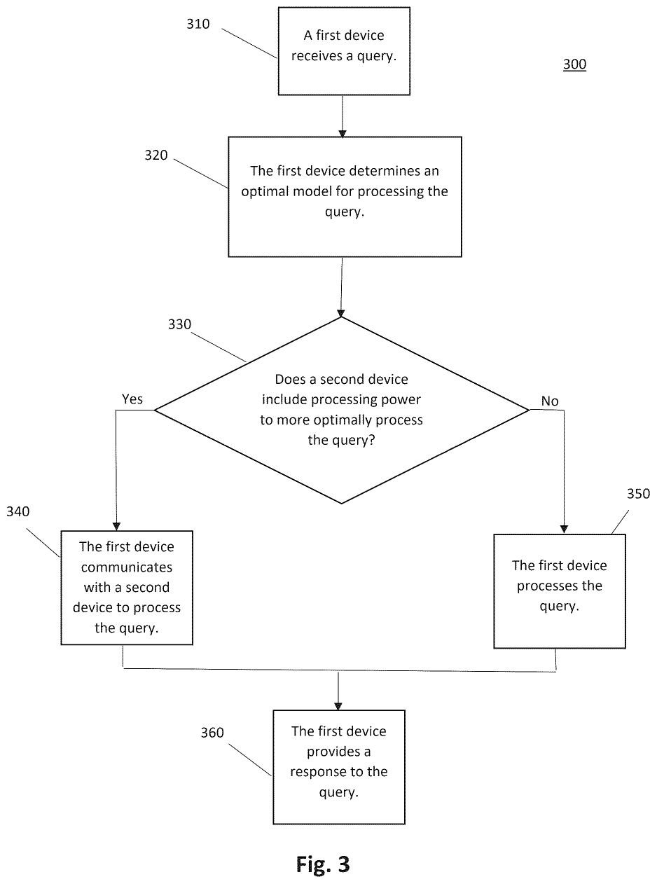

FIG. 3 shows a flow diagram of an example method 300 for processing a query in accordance with illustrative embodiments of the invention. In various embodiments, the method 300 may be implemented using the external devices 810 and computing devices 800 described above in FIG. 1 and FIG. 2.

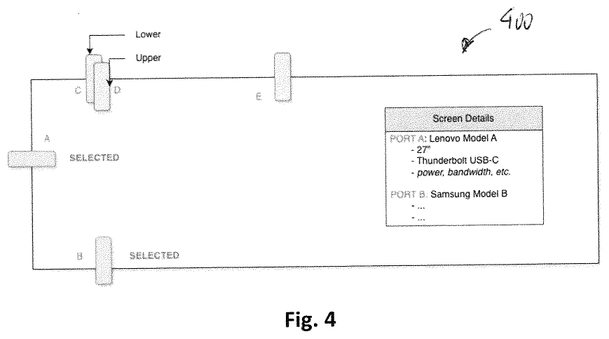

Accordingly, as mentioned above, at block 310, a first device receives a query. In various embodiments, the query may begin at a configuration (e.g., boot up) screen. FIG. 4 shows an example configuration screen 400 in accordance with illustrative embodiments of the invention. As shown in FIG. 4, various screens (e.g., external devices 810) may be configured and connected to one or more ports of the system. For example, as shown in FIG. 4, port A and port B may be selected, while port C, D (upper and lower areas of a screen) and E are available.

In various embodiments, the configuration screen may prompt for a system user login utilizing standard login credentials and/or biometric ID verification similar to fingerprint and/or face ID. After login, the system brings up a picture of the working environment (room) and the connected screens throughout the environment, in the form of a diagram of the room with screen highlights (see FIG. 4). The system may prompt the user to select which screens to activate. After screen configuration has been chosen, the operating system of choice is prompted for selection. Following this, the system loads the user's working environment according to the settings selections chosen by the user. In various embodiments, the screens/external devices depicted as connected to ports A, B, C, D and E may be external devices 810 shown in FIG. 1 and/or FIG. 2.

In various embodiments, the computing device 800 includes an operating system to process, for example, queries, such as those received at block 310 of method 300. In various embodiments, the operating system may include specialized operating systems which may be referred to as engines, which are tailored towards, for example, “Design Engine”, “Scientific Research Engine”, “Project Management & Planning Engine”, etc. Each engine may be highly configurable and can “couple” to other OS engines for integrated working environments. Each engine may have an operation “mode” which are essentially engines within engines that layout different system configurations and applications within a single engine that are optimized for specific workflow types within that engine.

This compartmentalization of the operating system, coupled with the extensive central processing unit/graphics processing unit (CPU/GPU) memory resources available, enables the system to partition suites of AI tools and models, that are otherwise resource intensive, in such a way as to optimize system operations and resource allocation, maintain system health and more. In various embodiments, users can configure their own modes, enable their own model suites, guided by the context model to ensure optimization of performance. Similarly, modes can be quickly switched and booted up without significant overload of background processes. Changing engines may be more involved than switching modes, but the concept of a coupling engines by activating engine modes allows for a cleaner option if needed.

As mentioned above, various modes may be included in the operating system at the configuration screen. In various embodiments, users may have operating modes by which the system operates, where each mode has a specific project type.

For example, the operating modes include A) Explore Mode which Project type contains an environment pertaining to a topic and is designed for learning, reading, developing understanding, compiling data of a specific type, playing around with specific tools, etc. B) Research & Project Mode which involves assigning a Project type for each research project, contains specific experiments, code development, model development, running simulations, producing results, deploying and manipulating data, etc., and C) Analysis Mode by which there is a Project type for analyzing the results of a specific experiment, or at a larger macro all experimental results of a Research Project, analyzing data collected in Explore mode, playing around with visualization, auto-plot generation, correlating results, comparing results to literature, otherwise. The Research and project mode includes not just research but deployment, business status monitoring, budgeting, and basic working functions as well, which can include utilizing models, tools, etc. to perform action on a system, in a market, controlling devices, or driving other actions on a local or distributed network system.

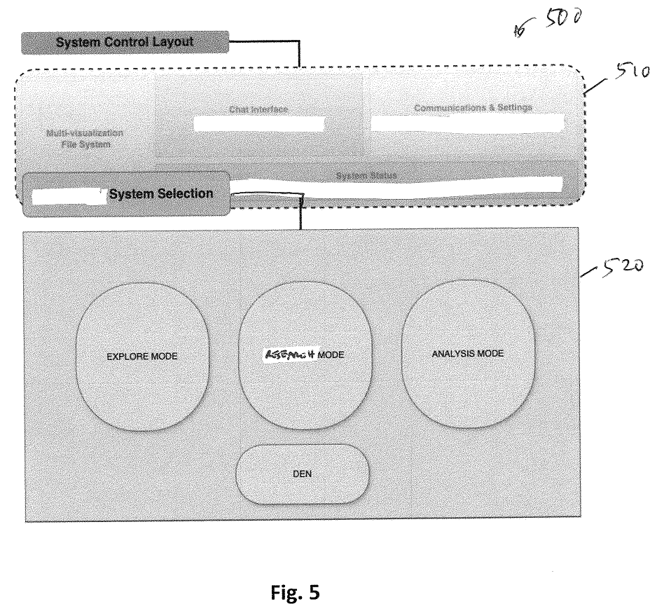

Accordingly, upon configuration, a user may utilize the distributed computing system. FIG. 5 shows an example system control and system selection screen 500 in accordance with illustrative embodiments of the invention.

As shown in FIG. 5, the example system control and system selection screen 500 includes a system control layout portion 510 and a system selection portion 520. In various embodiments, the system control layout portion may include a multi-visualization file system, chat interface, communications & settings, and system status areas. The chat interface may include inputs (left, center, right). The communications and settings area may include email, messaging, setting, system layout, etc. The system status area may display a resource being utilized, projects currently running, and/or other system information.

In various embodiments, the system selection portion 520 may include systems/modes that may be selected. For example, the system selection portion may include an explore mode, research mode and analysis mode selection. For purposes of example, the system selection portion 520 may display a home area for users to work in (e.g., den).

In various embodiments, users may employ linking of projects, data, etc., to one another to enable mapping of all, for example, work, data, analysis, research, learning and exploration, simulation, deployment, documents, references, to build networks that define a macro body or pillar of work. Hence, while a body of data may be utilized in one project, it can be accessed independently, utilized in another project, be linked to processed version of the data, linked to documents that reference or utilize that data, simulations from various research projects that deploy that data, several plots that display that data, for example.

Aside from mode operation, users can work in the “Den” which as mentioned above, may act as the system “Home” and for which there is no specific project assignment, and for which all applications are still available. In various embodiments, the scope of the Den is more for general, lightweight CPU usage and integration with social medias and apps or otherwise. In various embodiments, the den may be representative of “zooming out” to view all projects and work in dynamic represented fashions, collecting data and project experiments into a new project for analysis or otherwise, etc. Hence, in various embodiments, the den may be utilized for project layouts and linking.

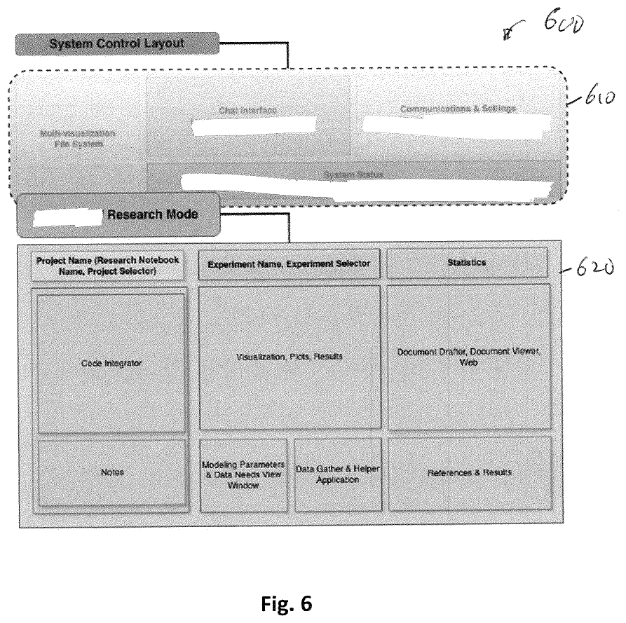

FIG. 6 shows and example system control and research mode screen 600 in accordance with illustrative embodiments of the invention. As shown in FIG. 6, the example system control and system selection screen 600 includes a system control layout portion 610 and a research mode selection portion 620.

In various embodiments, the system control layout portion 610 may include a multi-visualization file system, chat interface, communications & settings, and system status areas. The chat interface may include inputs (left, center, right). The communications and settings area may include email, messaging, setting, system layout, etc. The system status area may display a resource being utilized, projects currently running, and/or other system information. Accordingly, the system control layout portion 610 may be the same, or similar to the system control layout portion 510 of FIG. 5.

In various embodiments, the research mode selection portion 620 may be the result of a user selecting research mode from the screen shown in FIG. 5. As shown in FIG. 6, the research mode portion 620 may include a project name (e.g., research notebook name, project selector), experiment name/experiment selector, and statistics areas. Additionally, the research mode portion 620 may include a code integrator where code may be integrated with one another, notes for keeping notes and viewing them, a visualization/plot/results area where the same may be displayed, a modeling parameters & data needs view window for viewing the modeling parameters and a data gather & helper application for selecting for gathering data. In addition, a document drafter/document viewer/web area may be provided where documents may be created and viewed in addition to viewing on the web, and a references & results area where results and references may be viewed.

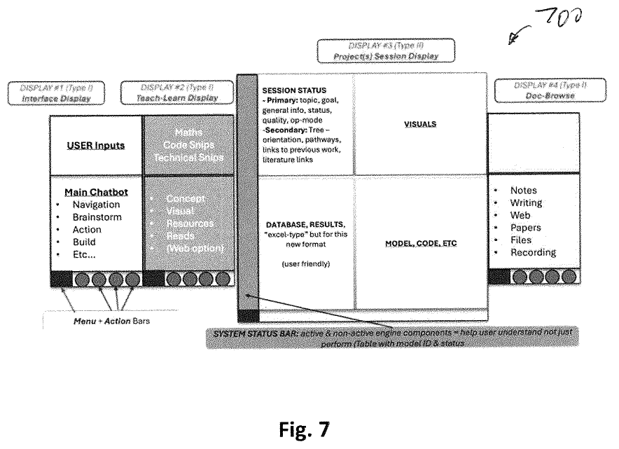

For purposes of example, for a research query at block 310 of method 300, FIG. 7 shows an example project using multiple screens 700 in accordance with illustrative embodiments of the invention.

As shown in FIG. 7, various displays (e.g., external device 810) may include a first display (display #1), a second display (display #2), a third display (display #3) and a fourth display (display #4). In various embodiments, display #1 may be a type I interface display, display #2 may be a type I tech-learn display, display #3 may be a type II project session display, and display #4 may be a type I document-browse display.

That is, in various embodiments, the interface display may include an ability to provide interfaces (e.g., user inputs, main chatbot: navigation, brainstorm, action, build, etc.). The teach-learn display may include a display of math/code snips/technical snips and, for example: concept, visual, resources, reads, and a web option.

In various embodiments, the project sessions display may includes a session status (e.g., primary—topic, goal, general info, status, quality, op-mode; and secondary—tree—orientation, pathways, links to previous work, literature links, etc.), database results (e. g,, user friendly “excel type), visuals, and model, code etc., areas. The document-browse area includes, in various embodiments, notes, writing, web, papers, files and recordings that can be accessed for browsing.

In various embodiments, menu and action bars may be included in one or more of the displays (as shown), and a system status bar may be included (e.g., in display #3) that shows active and non-active engine components to help the user understand and perform (e.g., a table with model ID and status information).

FIGS. 4-7 provide example screens that may be utilized in method 300 upon a query being received at block 310. In various examples, the first device of block 310 may include any combination of a computing device 800 and/or external device 810, where the external devices are the devices displaying the screens shown in FIGS. 4-7.

Accordingly, at block 320 of FIG. 3, the first device (e.g., computing device 800) determines an optimal model for processing the query. In various embodiments, the first device contextualizes a user's research problem, engineering problem, or other technical problem of any kind in any industry or any field, given a chat, bot or text as described above and herein (e.g., voice activated based interface that describes the overall nature of the situation.

In various embodiments, the first device understands the scope of the problem that the user is thinking of to the context, possible enabled by the user, and guide the user, or perform entirely for the user, through the process of creating a number of models and study outlines using any technical modeling simulation, forecasting, prediction, or other types of technical methods, informs the user of the data needed, and the data quality that is available any additional considerations that the user may want to be thinking of.

In various embodiments described herein, the first device may suggest novel uses of modeling components from different fields if useful, and finalize technical studies, execute, and run all the models and studies and automatically save any data, results or otherwise, analyze trends and all the results and suggest key takeaways with identifiers pointing to the areas in the data that suggest such trends, so that the user can verify, and/or auto plot on command any of the data that is resulted from the raw results from the model or process data for which data correlator modules also provide functionality.

Accordingly, to determine an optimal model (block 320), the first device defines the problem and objectives, understand the data characteristics (training, input types, output types), understands what people have done and what models they've worked with model pros/cons, selects the learning paradigm (e.g., UL/SL/RL—CNN/RNN) and refines a master list of models down to a subset of models.

In various embodiments, the first device may test domain models, evaluate model complexity and resources, perform iterative testing and validation, and summarize testing experiments and approach the full model build. In various embodiments, selecting the optimal AI model may include to clearly define the problem to solve and the objectives achieve. This involves understanding the specific task (e.g., classification, regression, clustering), the desired accuracy and performance metrics, and the business or research goals.

Understanding the data characteristics includes, for example, analyzing the characteristics of the data. In various embodiments, this includes determining the data type (structured vs. unstructured), the volume of data, the quality of data, and any inherent patterns or distributions. For example, image data may require convolutional neural networks (CNNs), while sequential data might benefit from recurrent neural networks (RNNs).

As mentioned above, a learning paradigm is selected as part of the optimal model determination. Accordingly, in various embodiments, the selection may depend on whether there is labeled data (supervised learning), unlabeled data (unsupervised learning), or if the model needs to learn through interaction (reinforcement learning). Accordingly, based upon the strength of a particular paradigm, it may be suited for different types of problems.

With regard to evaluating model complexity and resources, simple models (e.g., linear regression, decision trees) may be easy to implement and interpret but may not capture complex patterns. Advanced models (e.g., deep learning models) may require substantial computational power and large datasets but can learn intricate patterns.

Again, as mentioned above, selected models are iteratively tested and validated. In various embodiments, this includes training the models on the data, evaluating their performance using metrics such as accuracy, precision, recall, and F1 score, and refining the models based on the results. Cross-validation and hyperparameter tuning are performed in this process to ensure that the model generalizes well to new data.

In various embodiments, AI models may be classified by learning paradigm, complexity, functionality, and data type. When selecting a model for a specific problem, these classifications may be considered to provide a structured approach to identifying the most suitable model. The learning paradigm helps determine the appropriate training methodology, complexity addresses the trade-offs between simplicity and performance, functionality focuses on the specific tasks the model can perform, and data type ensures compatibility with the data being used. By understanding these dimensions, problem solving is systematically approached, ensuring that the selected model aligns with the application's requirements.

In practical engineering and product development, these classifications may guide the decision-making process. The learning paradigm determines how the model learns from data—whether through supervised, unsupervised, or reinforcement learning. Complexity considerations involve balancing computational resources with the model's performance needs. Functionality ensures that the model's capabilities match the desired outcome, whether it's classification, regression, or generation. Finally, data type compatibility ensures that the model can effectively process the available data, be it text, images, or structured data. Together, these dimensions help compartmentalize the approach to AI model selection, ensuring a methodical and effective strategy.

AI model selection determines how the model interacts with data during training. Supervised learning (SL) involves training the model on labeled data, making it suitable for tasks where historical data with known outcomes are available. Unsupervised learning (UL) does not rely on labeled data and is ideal for discovering hidden patterns or structures within the data. Reinforcement learning (RL) involves training the model through trial and error, with rewards guiding the learning process, making it suitable for sequential decision-making tasks.

In various embodiments, supervised learning may be used for classification and regression tasks where the outcome is known, and the goal is to learn a mapping from inputs to outputs. This method may be effective for tasks like image recognition, spam detection, and predictive analytics.

In various embodiments, unsupervised learning may be valuable for tasks that involve discovering patterns or groupings within data without predefined labels. It is used, for example, in clustering, anomaly detection, and association problems.

In various embodiments, reinforcement learning excels in environments where an agent learns to make a sequence of decisions by receiving rewards or penalties. It is used, for example, in robotics, game playing, and recommendation systems.

Simple neural networks, such as perceptrons and multilayer perceptrons (MLPs), are the most basic forms of neural network architectures. Perceptrons are used for binary classification tasks and consist of a single layer of weights connecting the input features to the output. MLPs extend this by adding multiple hidden layers, allowing the network to learn non-linear decision boundaries. These architectures are foundational and are typically used for straightforward tasks where the complexity of the data does not warrant more advanced models.

When selecting a simple neural network for a given problem, it is helpful to consider the nature of the task and the available computational resources. Simple neural networks are potentially ideal for problems where the relationships in the data are relatively straightforward and the dataset is not too large. They provide a good starting point for experimentation and can serve as baseline models against which more complex architectures can be compared. In various embodiments, balance simplicity and performance are balanced, ensuring that the model is sufficient to capture the underlying patterns without overcomplicating the solution.

Recurrent Neural Networks (RNNs) and Convolutional Neural Networks (CNNs) serve different purposes and are suited for different types of data. RNNs are designed to handle sequential data, such as time series or text, by maintaining a memory of previous inputs. This makes them particularly useful for tasks that involve temporal dependencies, like language modeling and speech recognition. CNNs, on the other hand, are specialized for processing grid-like data, such as images. They use convolutional layers to detect local patterns and hierarchical features, making them ideal for image classification and object detection.

When selecting between RNNs and CNNs, the nature of the data and the specific problem at hand may be considered. RNNs are advantageous when the data is sequential and the order of the inputs matters. They excel in applications where context from previous data points is essential for making accurate predictions. CNNs, however, are better suited for spatial data where the focus is on identifying and learning local patterns and features. In practice, the choice between RNN and CNN depends on whether the data's temporal or spatial characteristics are more critical for the task.

Deep Neural Networks (DNNs) represent a significant leap in complexity and capability compared to simpler neural networks. They consist of multiple layers of neurons, allowing them to learn hierarchical representations of data. DNNs are highly versatile and can be applied to a wide range of tasks, including image and speech recognition, natural language processing, and more. Two common types of DNNs are Deep Convolutional Neural Networks (DCNNs) and Long Short-Term Memory (LSTM) networks. DCNNs are used for advanced image and video recognition tasks, while LSTMs are designed for handling long-term dependencies in sequential data.

While DNNs offer substantial depth and capacity for complex tasks, they also require significant computational resources and large amounts of training data. This makes them less suitable for simpler tasks where lighter models would suffice. However, their ability to capture intricate patterns and relationships in data makes them invaluable for solving complex problems. In many cases, DNNs serve as the foundation for more advanced models, such as generative models and transformers, underscoring their importance in modern AI applications. When selecting a DNN, the task's complexity, the availability of computational resources, and the volume of training data may be considered.

Generative Adversarial Networks (GANs) and Variational Autoencoders (VAEs) are two types of generative models used for creating new data samples. GANs consist of two networks—a generator and a discriminator—that compete against each other. The generator creates fake data samples, while the discriminator attempts to distinguish between real and fake samples. This adversarial process leads to the generation of highly realistic data. VAEs, on the other hand, take a probabilistic approach to data generation. They encode input data into a latent space and then decode it back to reconstruct the original data, with the added ability to generate new samples by sampling from the latent space.

When choosing between GANs and VAEs, the specific application and the desired characteristics of the generated data is considered. GANs are particularly effective for tasks that require highly realistic samples, such as image generation and style transfer. They excel in scenarios where the goal is to create data that is indistinguishable from real data. VAEs, however, are valuable for tasks that require a structured latent space and the ability to generate diverse samples. They are commonly used in applications like anomaly detection and data compression. In various embodiments, the choice between GANs and VAEs depends on the trade-offs between realism and diversity in the generated data.

Transformer models, such as Bidirectional Encoder Representations from Transformer) (BERT) and Generative Pre-trained Transformer (GPT), have revolutionized natural language processing (NLP) by capturing long-range dependencies and contextual relationships within text. Transformers rely on self-attention mechanisms to weigh the importance of different words in a sentence, allowing them to understand context more effectively than previous models. BERT excels in tasks that require understanding the context within sentences, such as question answering and sentiment analysis. GPT on the other hand, is designed for generating coherent and contextually relevant text.

Selecting the right transformer model involves evaluating the specific needs of the application. BERT is well-suited for tasks that require a deep understanding of context and relationships between words within a sentence. It is pre-trained on large datasets and can be fine-tuned for various downstream tasks, making it versatile and powerful. GPT, however, is more focused on text generation and excels in applications like language modeling and creative writing. When choosing a transformer model, the task requirements, the model's pre-training, and fine-tuning capabilities, and the computational resources available are considered. The right choice can significantly enhance the performance and accuracy of NLP applications.

In various embodiments, functionality breakdown is considered for selecting the optimal AI model as it categorizes models based on their capabilities and intended applications. This dimensional framing provides a structured approach to evaluating models, ensuring that their strengths align with the specific needs of the problem at hand. Example dimensions of functionality include macro functionalities, specific functionalities, method functionalities, context frameworks, and applications. Each dimension offers a unique perspective on how models operate and where they are most effective.

Macro functionalities, for example, provide a broad categorization of AI models based on their primary capabilities. These functionalities are foundational and encompass the core tasks that models are designed to perform. Example macro functionalities include:
Classification: Categorizing data into predefined classes. Common models include Support Vector Machines (SVMs) and Convolutional Neural Networks (CNNs).
Regression: Predicting continuous values based on input data. Typical models are Linear Regression and Multilayer Perceptrons (MLPs).
Data Generation: Creating new data instances, often used in applications like image synthesis and text generation. Examples include Generative Adversarial Networks (GANs) and Variational Autoencoders (VAEs).

Specific functionalities delve deeper into the detailed tasks that AI models can perform. This dimension helps in pinpointing the exact capabilities required for a given application. Examples of specific functionalities include:
Sequence Prediction: Used for tasks that involve predicting future values in a sequence, such as time series forecasting and
language modeling. Models include Recurrent Neural Networks (RNNs) and Long Short-Term Memory networks (LSTMs).
Anomaly Detection: Identifying unusual patterns or outliers in data, critical for applications like fraud detection and network security. Common models are Autoencoders and Isolation Forests.

Method functionalities focus on the practical aspects of implementing AI models, such as ease of implementation, computational requirements, and interpretability. This dimension is utilized for evaluating the feasibility of deploying models in real-world scenarios. Example method functionalities include:
Ease of Implementation: Models that are straightforward to implement and interpret, such as Logistic Regression and Naive Bayes. Computational Requirements: Advanced models that require substantial computational resources, including CNNs and Transformers.
Interpretability: Models that are easy to understand and explain, such as Decision Trees and Linear Regression.

Context frameworks provide a comprehensive view of how AI models fit within broader systems and workflows. This dimension includes integration with existing systems, scalability, and real-time performance, guiding the practical application of models. Examples of context frameworks include:
Integration: Models that easily integrate with existing systems, such as API-based models and modular architectures.
Scalability: Models that scale well with increasing data volumes, including distributed learning models and cloud-based solutions.
Real-Time Performance: Models that perform well in real-time applications, such as real-time anomaly detection models and low-latency prediction models.

Applications focus on the practical uses of AI models across various industries and fields. This dimension helps in aligning the model's functionality with specific real-world tasks. Example application areas include:
Healthcare: Applications like medical diagnostics and drug discovery, using models such as CNNs and GANs.
Finance: Tasks like risk assessment and fraud detection, employing models like LSTMs and RNNs.
Autonomous Systems: Capabilities such as self-driving cars and robotics, utilizing models like Reinforcement Learning (RL) and GANs.
Natural Language Processing (NLP): Enhancements in text generation and sentiment analysis, leveraging models like Transformers and BERT.

By utilizing dimensional framework for functionality at block 320, a detailed and structured way to evaluate and select AI models is established, ensuring that their capabilities align precisely with the specific needs of the problem at hand.

In various embodiments, understanding and compartmentalizing AI models by data types is utilized for selecting the optimal model for a problem. Data types dictate the nature of the information being processed and influence the choice of model architectures. By categorizing models based on their compatibility with different data types, it may be ensured that the selected model is optimized for the specific characteristics of the data, leading to more accurate and efficient outcomes.

For example, structured data refers to information that is organized in a predefined manner, typically in tabular formats with rows and columns. This type of data is often numerical or categorical and is stored in databases or spreadsheets. Example models that work well with structured data may include:
Decision Trees: Effective for classification and regression tasks involving tabular data.
Gradient Boosting Machines (GBM): Robust for predictive modeling with structured data.
Linear Regression: Suitable for simple linear relationships within structured datasets.

Unstructured data is data that lacks a predefined format and can include text, images, audio, and video. This type of data is more complex and requires specialized models to extract meaningful patterns. Example models for unstructured data include:
Convolutional Neural Networks (CNNs): Ideal for image and video data, capturing spatial hierarchies.
Recurrent Neural Networks (RNNs): Suitable for sequential data like text and audio, capturing temporal dependencies.
Transformers: Effective for natural language processing tasks, handling long-range dependencies in text data.

Semi-structured data is data that does not conform to strict tabular formats but contains tags or markers to separate data elements. Examples include JSON, XML, and HTML files. Example models that can handle semi-structured data are:
Graph Neural Networks (GNNs): Suitable for data represented as graphs or networks.
Autoencoders: Effective for encoding and decoding semi-structured data into meaningful representations.

Time-series data is a sequence of data points collected or recorded at successive points in time. This type of data is common in financial markets, weather forecasting, and sensor readings. Example models that excel with time-series data include:
ARIMA (AutoRegressive Integrated Moving Average): Traditional statistical model for time-series forecasting.
LSTM (Long Short-Term Memory): A type of RNN designed to capture long-term dependencies in sequential data.
Prophet: An open-source forecasting tool developed by Facebook, suitable for time-series with strong seasonal effects.

Multimodal data is data that involves multiple data types, such as text, images, and audio, combined to provide a comprehensive understanding of the information. Example models capable of processing multimodal data include:
Multimodal Transformers: Capable of handling and integrating multiple data types within a single model architecture.
Deep Boltzmann Machines: Suitable for modeling complex relationships between different data modalities.

By compartmentalizing AI models based on data types, model capabilities may be more effectively aligned with the specific characteristics of the data, leading to more effective and tailored AI solutions. Accordingly, the selected model is not only compatible with the data but also optimized to extract the most relevant patterns and insights.

Accordingly, once the first device determines an optimal model for processing the query (block 320), then the first device determines whether a second device includes processing power to more optimally process the query at block 330. For example, based on the parameters described above relating to selecting/determining an optimal model, the first device may determine that the optimal model exists or should be trained on either the first device or the second device. In various embodiments, additional devices (e.g., a third device and so on) may also be determined to more optimally process the query or assist in processing.

In various embodiments, the first device may be a computing device 800 of the distributed computing system 100 that is connected to, or otherwise has access to, other computing devices 800 of the distributed computing system. Accordingly, the first device may consider whether another computing device may more optimally process the query based upon the parameters described above.

If a second device would more optimally process the query, then, at block 340, the first device communicates with the second device to process the query. The first device then receives the information/result from the query and provides the user a response to the query at block 360. In various embodiments, the first device is a computing device 800 that provides the information for display on a connected external device 810 (e.g., screen) for display in a region or area as described above in FIG. 6.

If a second device would not more optimally process the query, then, at block 340, the first device processes the query at block 350. The first device then provides the user a response to the query at block 360. In various embodiments, the first device is a computing device 800 that provides the information for display on a connected external device 810 (e.g., screen) for display in a region or area as described above in FIG. 6.

The operations and blocks of any method described above, such as of FIG. 3 are merely illustrative, and variations are contemplated to be within the scope of the present disclosure. In embodiments, the operations and blocks may include other operations not illustrated. In embodiments, the operations and blocks may not include every operation illustrated. In embodiments, the operations and blocks may be implemented in a different order than that illustrated. Such and other embodiments are contemplated to be within the scope of the present disclosure. Persons of skill in the art will appreciate that, although various example components may be described as performing various functions, operations and blocks, other components may perform those functions, operations and blocks described above.

FIG. 8 shows an example computing device in accordance with various embodiments.

For example, FIG. 8 schematically shows a computing device 802 in accordance with various embodiments. The computing device 802 is one example of a computing device which is used to perform one or more operations of method/process 300 illustrated in FIG. 3. In various embodiments, the computing device 802 may be a controller that performs the operations/blocks of method/process 300 described above. In various embodiments, the controller may reside within a first device that includes the first computing process or a second device that includes the second computing process. In various embodiments, the controller may reside external to any devices including the first computing process and/or the second computing process.

The computing device 800 includes a processing device 802, an input/output device 804, and a memory device 806. The computing device 802 may be a stand-alone device, an embedded system, or a plurality of devices configured to perform the functions described with respect to one of the components of power network 100. Furthermore, the computing device 802 may communicate with one or more external devices (not shown).

The input/output device 804 enables the computing device 802 to communicate with an external device (not shown). For example, the input/output device 804 may be a network adapter, a network credential, an interface, or a port (e.g., a USB port, serial port, parallel port, an analog port, a digital port, VGA, DVI, HDMI, FireWire, CAT 5, Ethernet, fiber, or any other type of port or interface), among other things. The input/output device 804 may be comprised of hardware, software, or firmware. The input/output device 804 may have more than one of these adapters, credentials, interfaces, or ports, such as a first port for receiving data and a second port for transmitting data, among other things.

The external device may be any type of device that allows data to be input or output from the computing device 802. For example, the external device may be a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device may be integrated into the computing device 802. More than one external device may be in communication with the computing device 802.

The processing device 802 may be a programmable type, a dedicated, hardwired state machine, or a combination thereof. The processing device 802 may further include multiple processors, Arithmetic-Logic Units (ALUs), Central Processing Units (CPUs), Digital Signal Processors (DSPs), or Field-programmable Gate Arrays (FPGA), among other things. For forms of the processing device 802 with multiple processing units, distributed, pipelined, or parallel processing may be used. The processing device 802 may be dedicated to performance of just the operations described herein or may be used in one or more additional applications. The processing device 802 may be of a programmable variety that executes processes and processes data in accordance with programming instructions (such as software or firmware) stored in the memory device 806. Alternatively or additionally, programming instructions are at least partially defined by hardwired logic or other hardware. The processing device 802 may be comprised of one or more components of any type suitable to process the signals received from the input/output device 804 or elsewhere, and provide desired output signals. Such components may include digital circuitry, analog circuitry, or a combination thereof.

The memory device 806 in different embodiments may be of one or more types, such as a solid-state variety, electromagnetic variety, optical variety, or a combination of these forms, to name but a few examples. Furthermore, the memory device 806 may be volatile, nonvolatile, transitory, non-transitory or a combination of these types, and some or all of the memory device 806 may be of a portable variety, such as a disk, tape, memory stick, or cartridge, to name but a few examples. In addition, the memory device 806 may store data which is manipulated by the processing device 802, such as data representative of signals received from or sent to the input/output device 804 in addition to or in lieu of storing programming instructions, among other things. As shown in FIG. 8, the memory device 806 may be included with the processing device 802 or coupled to the processing device 802, but need not be included with both.

The embodiments of the invention described above are intended to be merely exemplary; numerous variations and modifications will be apparent to those skilled in the art.

What is claimed is:

1. A method of processing data in a distributed computing system, the method comprising:
receiving, by a first device, a query from a user;
determining, by the first device, based on the query, a model for processing the query;
determining, by the first device, whether the first device or a second device includes the model for processing the query;
based on whether the first device or the second device includes the model for processing the query, transmitting, by the first device, the query to the second device for processing; and
providing, by the first device, a response to the query to the user.

2. The method of claim 1, wherein the model is an artificial intelligence (AI) model.

3. The method of claim 1, wherein the first device is a computing device.

4. The method of claim 3, wherein the first device is in communication with an input that receives the query from the user.

5. The method of claim 1, wherein the determining a model for processing the query includes determining a complexity of the model for processing the query.

6. The method of claim 5, wherein the complexity of the model comprises one or more of the following: a simple neural network, a recurrent neural network (RNN), a convolutional neural network (CNN), a deep neural network (DNN), a generative adversarial network (GAN), a variational autoencoder (VAE), a transformer model, or an advanced model.

7. The method of claim 1, wherein the determining a model for the processing of the query by the first device includes:
defining a problem and objectives;
determining data characteristics;
determining one or more models the user has utilized previously;
selecting a learning paradigm;
evaluating model complexities and resources; and
performing iterative testing and validation of the model.

8. A distributed computing system, comprising:
a first device comprising one or more processors in communication with a memory and an input,
the processor of the first device configured to receive a query from a user via the input, determine, based on the query, a model for processing the query, determine whether the first device or a second device includes the model for processing the query, based on whether the first device or the second device includes the model for processing the query, transmit the query to the second device for processing, and provide a response to the query to the user via an output.

9. The distributed computing system of claim 8, wherein the model is an artificial intelligence (AI) model.

10. The distributed computing system of claim 8, wherein the first device is a computing device.

11. The distributed computing system of claim 10, wherein the first device is in communication with an input that receives the query from the user.

12. The distributed computing system of claim 8, wherein the determining a model for processing the query includes determining a complexity of the model for processing the query.

13. The distributed computing system of claim 12, wherein the complexity of the model comprises one or more of the following: a simple neural network, a recurrent neural network (RNN), a convolutional neural network (CNN), a deep neural network (DNN), a generative adversarial network (GAN), a variational autoencoder (VAE), a transformer model, or an advanced model.

14. The distributed computing system of claim 8, wherein the processor of the first device is further configured to:
define a problem and objectives;
determine data characteristics;
determine one or more models the user has utilized previously;
select a learning paradigm;
evaluate model complexities and resources; and
perform iterative testing and validation of the model.

15. A computer program product for use on a computer system, the computer program product comprising a tangible, non-transient computer usable medium having computer readable program code thereon, the computer readable program code comprising:
program code for receiving, by a first device, a query from a user;
program code for determining, by the first device, based on the query, a model for processing the query;
program code for determining, by the first device, whether the first device or a second device includes the model for processing the query;
program code for, based on whether the first device or the second device includes the model for processing the query, transmitting, by the first device, the query to the second device for processing; and
program code for providing, by the first device, a response to the query to the user.

16. The computer program product of claim 15, wherein the model is an artificial intelligence (AI) model.

17. The computer program product of claim 15, wherein the first device is a computing device.

18. The computer program product of claim 17, wherein the first device is in communication with an input that receives the query from the user.

19. The computer program product of claim 1, further comprises program code for determining a complexity of the model for processing the query.

20. The computer program product of claim 15, further comprising:
program code for defining a problem and objectives;
program code for determining data characteristics;
program code for determining one or more models the user has utilized previously;
program code for selecting a learning paradigm;
program code for evaluating model complexities and resources; and
program code for performing iterative testing and validation of the model.
